(19) United States
(12) Patent Application Publication
(10) Pub. No.: US 2026/0162884 A1
(43) Pub. Date: Jun. 11, 2026

(54) COIL COMPONENT

(71) Applicant: TDK Corporation, Tokyo (JP)

(72) Inventors: Yusuke NAGAI, Tokyo (JP); Kazuhiro Ebina, Tokyo (JP); Takahiro Sato, Tokyo (JP); Makoto Yoshino, Tokyo (JP); Masaki Takahashi, Tokyo (JP); Yuya Ishima, Tokyo (JP); Takuya Miyashita, Tokyo (JP)

(73) Assignee: TDK Corporation, Tokyo (JP)

(21) Appl. No.: 19/410,332

(22) Filed: Dec. 5, 2025

(30) Foreign Application Priority Data
Dec. 10, 2024 (JP) 2024-215502

(51) Int. Cl. H01F 27/34; H01F 17/00; H01F 17/04; H01F 27/29

(52) U.S. Cl. CPC H01F 27/34; H01F 17/0013; H01F 17/04; H01F 2017/048; H01F 27/292

(57) ABSTRACT

A coil component includes: an element body including a main surface, and a first side surface and a second side surface facing each other in a direction along the main surface; a coil disposed inside the element body and including a coil axis perpendicular to the main surface; and an external electrode disposed at least on the first side surface, wherein the element body includes: a first element body region located between the first side surface and the coil in the direction; and a second element body region located between the second side surface and the coil in the direction, and wherein the first element body region has a resistivity higher than a resistivity of the second element body region.

### TECHNICAL FIELD

The present disclosure relates to a coil component. This application claims priority based on Japanese Patent Application No. 2024-215502 filed on Dec. 10, 2024, the entire contents of which are incorporated herein by reference.

### BACKGROUND

A coil component that includes an element body, a coil disposed inside the element body, and an external electrode disposed on the element body is known (see, for example, JP 2021-108332). In this coil component, the element body has a main surface, and a first side surface and a second side surface facing each other in a direction along the main surface. The coil has a coil axis perpendicular to the main surface. The distance between the coil and the first side surface is less than the distance between the coil and the second side surface.

### SUMMARY

In the above coil component, since the distance between the coil and the first side surface is short, a short circuit may occur between the coil and the external electrode disposed on the first side surface.

It is an object of the present disclosure to provide a coil component capable of suppressing the occurrence of a short circuit.
(1) A coil component according to an aspect of the present disclosure includes: an element body including a main surface, and a first side surface and a second side surface facing each other in a direction along the main surface; a coil disposed inside the element body and including a coil axis perpendicular to the main surface; and an external electrode disposed at least on the first side surface, wherein the element body includes: a first element body region located between the first side surface and the coil in the direction; and a second element body region located between the second side surface and the coil in the direction, and wherein the first element body region has a resistivity higher than a resistivity of the second element body region.

In the above coil component, the first element body region which has a high resistivity is located between the first side surface on which the external electrode is disposed and the coil. Accordingly, the occurrence of a short circuit between the coil and the external electrode disposed on the first side surface can be suppressed.
(2) In the coil component of (1) above, the element body may include a plurality of metallic magnetic particles and a resin present between the plurality of metallic magnetic particles, and a proportion of the first element body region occupied by voids between the plurality of metallic magnetic particles in which the resin is not present may be less than a proportion of the second element body region occupied by the voids. In this case, the resistivity of the first element body region can be made higher than the resistivity of the second element body region.
(3) In the coil component of (1) or (2) above, the element body may include a plurality of metallic magnetic particles and a resin present between the plurality of metallic magnetic particles, and a proportion of the first element body region occupied by the resin may be greater than a proportion of the second element body region occupied by the resin. In this case, the resistivity of the first element body region can be made higher than the resistivity of the second element body region.
(4) In the coil component of any one of (1) to (3) above, the element body may include a plurality of metallic magnetic particles, insulating films covering surfaces of the plurality of metallic magnetic particles, and a resin present between the plurality of metallic magnetic particles, and a proportion of the first element body region occupied by the insulating films may be greater than a proportion of the second element body region occupied by the insulating films. In this case, the resistivity of the first element body region can be made higher than the resistivity of the second element body region.
(5) In the coil component of (4) above, the plurality of metallic magnetic particles in the first element body region may have an average particle size smaller than an average particle size of the plurality of metallic magnetic particles in the second element body region. In this case, the proportion of the first element body region occupied by the insulating films can be made greater than the proportion of the second element body region occupied by the insulating films. As a result, the resistivity of the first element body region can be made higher than the resistivity of the second element body region.
(6) In the coil component of any one of (1) to (5) above, the first element body region may be shorter than the second element body region in the direction. In this case, a configuration in which the resistivity of the first element body region is made higher is more effective for suppressing the occurrence of a short circuit.
(7) In the coil component of any one of (1) to (6) above, the coil may include a first coil region adjacent to the first element body region and a second coil region adjacent to the second element body region, and a number of turns of the coil in the first coil region may be less than a number of turns of the coil in the second coil region. In this case, even if the coil is disposed closer to the first side surface than to the second side surface to adjust the difference in leakage magnetic flux caused by the difference in the number of turns between the first coil region and the second coil region, the resistivity of the first element body region is high. Accordingly, the occurrence of a short circuit can be suppressed.
(8) In the coil component of any one of (1) to (7) above, the coil may include a first coil region adjacent to the first element body region and a second coil region adjacent to the second element body region, and an area of the coil in contact with the first element body region may be greater than an area of the coil in contact with the second element body region. In this case, the configuration in which the resistivity of the first element body region is made higher is more effective for suppressing the occurrence of a short circuit.
(9) In the coil component of any one of (1) to (8) above, the first element body region may have a length equivalent to a length of the element body in a first direction perpendicular to each of the direction and the coil axis. In this case, the occurrence of a short circuit can be further suppressed.
(10) In the coil component of any one of (1) to (9) above, the element body may further include a third side surface adjacent to each of the main surface, the first side surface, and the second side surface, the external electrode may include a first electrode portion disposed on the first side surface and a second electrode portion disposed on the third side surface, and the first element body region may include a first region portion located between the first side surface and the coil and a second region portion located between the third side surface and the coil. In this case, the first region portion of the first element body region having a high resistivity is located between the first side surface on which the first electrode portion of the external electrode is disposed and the coil. Accordingly, the occurrence of a short circuit between the coil and the first side surface can be suppressed. Additionally, the second region portion of the first element body region having a high resistivity is located between the third side surface on which the second electrode portion of the external electrode is disposed and the coil. Accordingly, the occurrence of a short circuit between the coil and the third side surface can be suppressed.

### BRIEF DESCRIPTION OF THE DRAWINGS

FIG. 1 is a perspective view of a coil component according to a first embodiment.

FIG. 2 is a diagram illustrating a cross-sectional configuration of the coil component of FIG. 1.

FIG. 3 is a schematic cross-sectional view of an element body.

FIG. 4 is a diagram illustrating a layer configuration of the coil component of FIG. 1.

FIG. 5 is a plan view of the coil component of FIG. 1.

FIG. 6 is a diagram illustrating a layer configuration of a coil component according to a second embodiment.

FIG. 7 is a diagram illustrating a connection relationship of conductive pattern layers.

FIG. 8 is a diagram illustrating a layer configuration of a coil component according to a third embodiment.

FIG. 9 is a plan view of a coil conductor.

FIG. 10 is a plan view of the coil component of FIG. 8.

FIG. 11 is a plan view of a coil component according to a fourth embodiment.

FIG. 12 is a plan view of a coil component according to a fifth embodiment.

FIG. 13 is a plan view of a coil component according to a sixth embodiment.

FIG. 14 is a plan view of a coil component according to a seventh embodiment.

FIG. 15 is a plan view of a coil component according to an eighth embodiment.

### DETAILED DESCRIPTION

Embodiments of the present disclosure will be described in detail below with reference to the accompanying drawings. Same reference signs are given to the same or corresponding elements in the description of the drawings, and redundant description will be omitted.

### First Embodiment

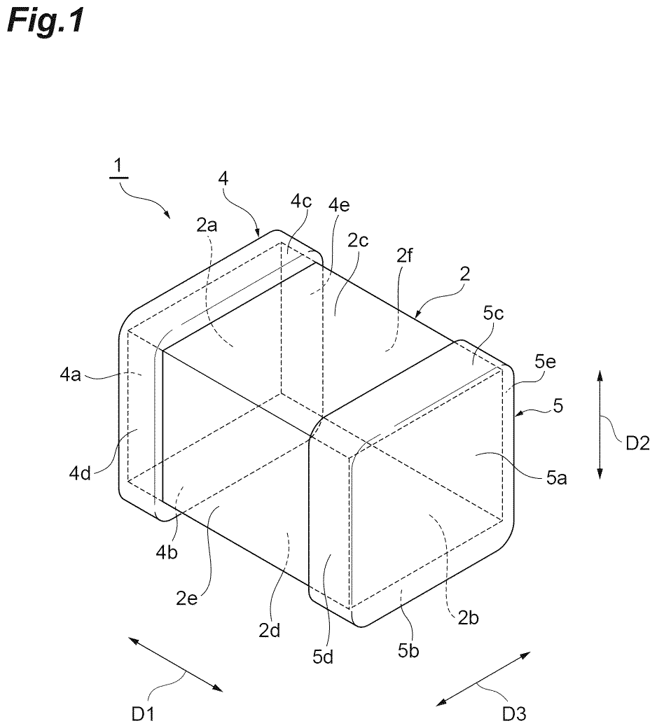

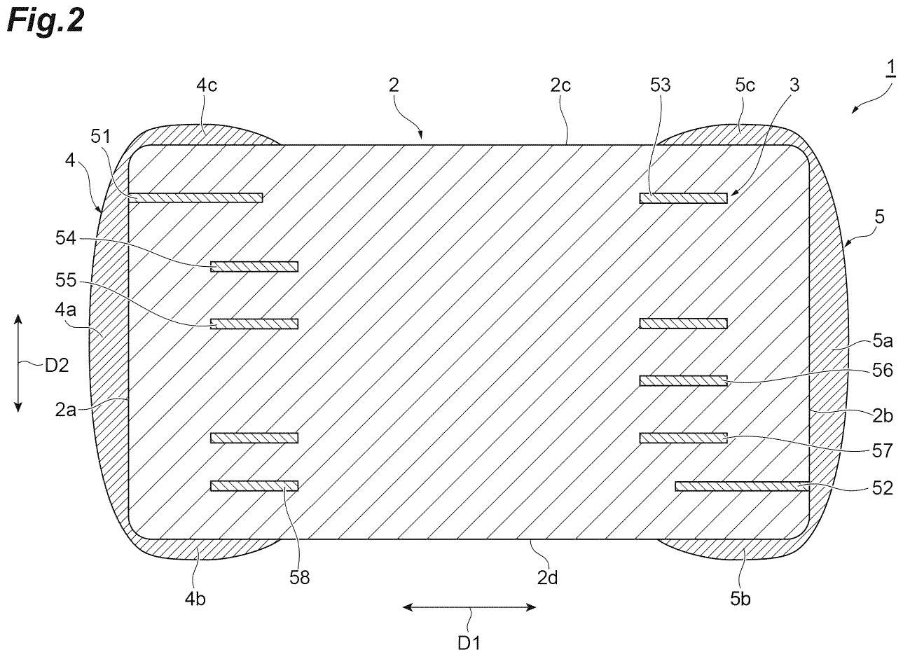

A coil component 1 according to a first embodiment will be described with reference to FIGS. 1 to 5. As illustrated in FIGS. 1 and 2, the coil component 1 includes an element body 2, a coil 3, an external electrode 4, an external electrode 5, a connecting conductor 51, and a connecting conductor 52. The coil 3, the connecting conductor 51, and the connecting conductor 52 are internal conductors and are disposed inside the element body 2. The coil component 1 is a multilayer coil component and is formed by a plurality of magnetic layers 11 being laminated. The coil component 1 can be applied, for example, to a bead inductor or a power inductor. The external electrodes 4, 5 are respectively disposed on both end portions of the element body 2.

The element body 2 has a rectangular parallelepiped shape. The rectangular parallelepiped shape includes a rectangular parallelepiped shape in which the corners and edges are chamfered, and a rectangular parallelepiped shape in which the corners and edges are rounded. The element body 2 has end surfaces 2a, 2b that face each other, a pair of main surfaces 2c, 2d, and a pair of side surfaces 2e, 2f.

The end surface 2a and the end surface 2b face each other in a first direction D1. The main surface 2c and the main surface 2d face each other in a second direction D2. The side surface 2e and the side surface 2f face each other in a third direction D3. The first direction D1, the second direction D2, and the third direction D3 intersect (in this embodiment, are perpendicular to) each other. The main surface 2d is, for example, the surface that faces an electronic device not shown when the coil component 1 is mounted to the electronic device. The electronic device includes, for example, a circuit board or an electronic component. In this embodiment, the main surface 2d is a mounting surface. The end surface 2b is adjacent to each of the main surface 2d, the side surface 2e, and the side surface 2f.

Each of the end surfaces 2a, 2b and the side surfaces 2e, 2f is a surface adjacent to the main surface 2d. Each of the first direction D1 and the third direction D3 is a direction along the main surface 2d. The second direction D2 is a direction that intersects (in this embodiment, is perpendicular to) the main surface 2d.

The element body 2 is formed by the plurality of magnetic layers 11 being laminated. The magnetic layers 11 are laminated in the second direction D2. The element body 2 has the plurality of magnetic layers 11 that are laminated. In an actual element body 2, the plurality of magnetic layers 11 are integrated such that the boundaries between the layers thereof cannot be visually recognized.

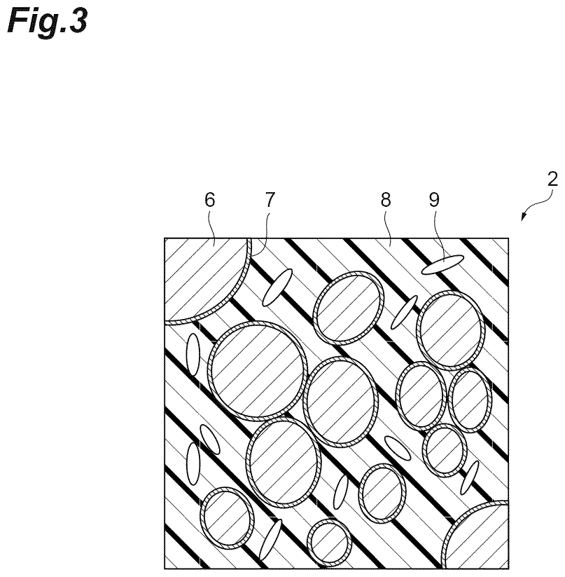

As illustrated in FIG. 3, each magnetic layer 11 includes a plurality of metallic magnetic particles 6. The metallic magnetic particles 6 are formed, for example, of a soft magnetic alloy. The soft magnetic alloy is, for example, an Fe—Si alloy. In the case in which the soft magnetic alloy is an Fe—Si alloy, the soft magnetic alloy may include P. The soft magnetic alloy may be, for example, an Fe—Ni—Si—M alloy. “M” includes one or more elements selected from Co, Cr, Mn, P, Ti, Zr, Hf, Nb, Ta, Mo, Mg, Ca, Sr, Ba, Zn, B, Al, and rare earth elements.

The metallic magnetic particles 6 of the entire element body 2 have an average particle size of 0.5 μm or more and 15 μm or less. In this embodiment, the average particle size of the metallic magnetic particles 6 of the entire element body 2 is 5 μm. The “average particle size” is calculated, for example, from at least one cross-section of the element body 2. In one example, it refers to a particle size at 50% cumulative in the particle size distribution determined by image processing of at least one cross-sectional image of the element body 2. The “average particle size” may refer to a particle size at 50% cumulative in the particle size distribution determined by a laser diffraction scattering method.

The magnetic layer 11 includes insulating films 7 that cover the surfaces of the plurality of metallic magnetic particles 6. The insulating films 7 have higher electrical insulation than the metallic magnetic particles 6. In the magnetic layer 11, the metallic magnetic particles 6 are bonded to each other by the insulating films 7 formed on the surfaces of the metallic magnetic particles 6 and bonded to each other. In the magnetic layer 11, the metallic magnetic particles 6 are electrically insulated from each other by the bonding of the insulating films 7 to each other. The insulating films 7 have a thickness of, for example, 5 nm or more and 60 nm or less. Each of the insulating films 7 may be formed of one or a plurality of layers. In the case in which the insulating film 7 is formed of a plurality of layers, the thickness of each layer may be the same or different. Each of the insulating films 7 is, for example, an oxide film. The oxide film may include, as the main component, for example, an oxide containing at least one of Cr and Al or an oxide containing Fe and at least one of Cr and Al.

The element body 2 includes a resin 8. The resin 8 is present between the plurality of metallic magnetic particles 6. The resin 8 is a resin having electrical insulation (insulating resin). The insulating resin includes, for example, a silicone resin, a phenol resin, an acrylic resin, or an epoxy resin.

As illustrated in FIGS. 1 and 2, the external electrodes 4, 5 are respectively disposed on both end portions of the element body 2 in the first direction D1. The external electrodes 4, 5 are spaced apart from each other in the first direction D1. The external electrode 4 is disposed on the end portion of the element body 2 on the end surface 2a side. The external electrode 5 is disposed on the end portion of the element body 2 on the end surface 2b side. The external electrodes 4, 5 include a conductive material. The conductive material is, for example, Ag or Pd. The external electrodes 4, 5 are formed as sintered bodies of a conductive paste. The conductive paste includes a conductive metal powder and glass frit. The conductive metal powder is, for example, an Ag powder or a Pd powder. A plating layer is formed on the surfaces of the external electrodes 4, 5. The plating layer is formed, for example, by electroplating. The electroplating is, for example, electrolytic Ni plating or electrolytic Sn plating.

The external electrode 4 is disposed on the end surface 2a, the main surface 2c, the main surface 2d, the side surface 2e, and the side surface 2f. The external electrode 4 includes five electrode portions. The external electrode 4 includes an electrode portion 4a located on the end surface 2a, an electrode portion 4b located on the main surface 2d, an electrode portion 4c located on the main surface 2c, an electrode portion 4d located on the side surface 2e, and an electrode portion 4e located on the side surface 2f. The electrode portion 4a covers the entirety of the end surface 2a. The electrode portion 4b covers a part of the main surface 2d. The electrode portion 4c covers a part of the main surface 2c. The electrode portion 4d covers a part of the side surface 2e. The electrode portion 4e covers a part of the side surface 2f. The five electrode portions 4a, 4b, 4c, 4d, 4e are integrally formed.

The external electrode 5 is disposed on the end surface 2b, the main surface 2c, the main surface 2d, the side surface 2e, and the side surface 2f. The external electrode 5 includes five electrode portions. The external electrode 5 includes an electrode portion 5a located on the end surface 2b, an electrode portion 5b located on the main surface 2d, an electrode portion 5c located on the main surface 2c, an electrode portion 5d located on the side surface 2e, and an electrode portion 5e located on the side surface 2f. The electrode portion 5a covers the entirety of the end surface 2b. The electrode portion 5b covers a part of the main surface 2d. The electrode portion 5c covers a part of the main surface 2c. The electrode portion 5d covers a part of the side surface 2e. The electrode portion 5e covers a part of the side surface 2f. The five electrode portions 5a, 5b, 5c, 5d, 5e are integrally formed.

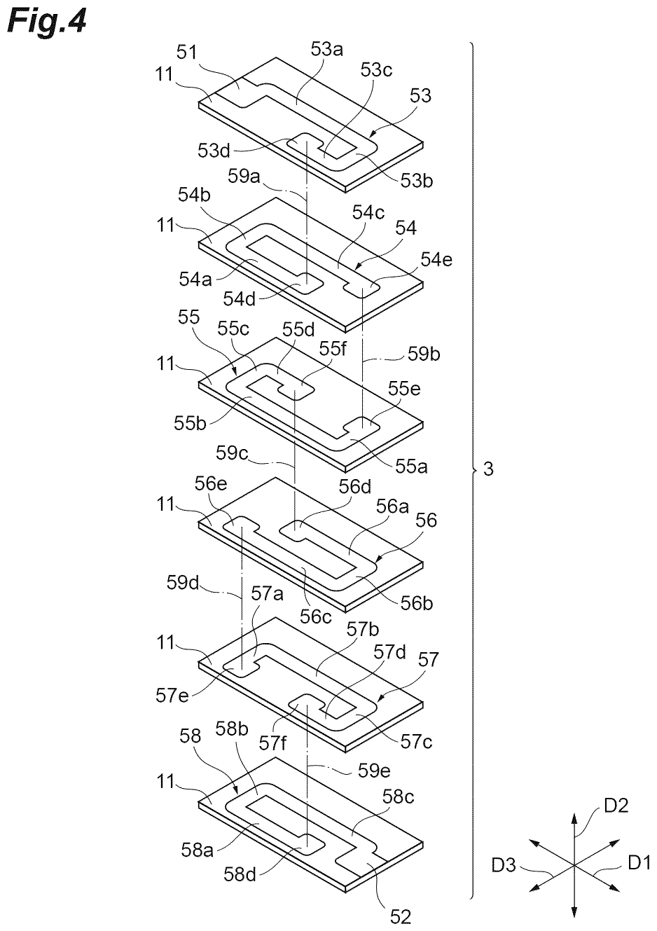

As illustrated in FIGS. 2, 4, and 5, the coil 3 is disposed inside the element body 2. Although omitted in FIG. 4, the magnetic layer 11 having the main surface 2c is disposed on a coil conductor 53, and the coil 3 is not exposed on the outer surface of the element body 2. The coil 3 has a coil axis Ax perpendicular to the main surface 2c and the main surface 2d. The coil axis Ax extends along the second direction D2. The coil 3 includes a plurality of coil conductors 53 to 58. The plurality of coil conductors 53 to 58 include a conductive material (e.g., Ag or Pd). The plurality of coil conductors 53 to 58 are formed as sintered bodies of a conductive paste including a conductive material (e.g., an Ag powder or a Pd powder).

The plurality of coil conductors 53 to 58 are arranged in a lamination direction of the magnetic layers 11 inside the element body 2. The plurality of coil conductors 53 to 58 are arranged in the order of the coil conductor 53, the coil conductor 54, the coil conductor 55, the coil conductor 56, the coil conductor 57, and the coil conductor 58. The coil conductor 53 is disposed closer to the main surface 2c. The coil conductor 58 is disposed closer to the main surface 2d.

End portions of the coil conductors 53 to 58 are connected to each other by through-hole conductors 59a to 59e. The coil conductors 53 to 58 are electrically connected to each other by the through-hole conductors 59a to 59e. The coil 3 is formed by the plurality of coil conductors 53 to 58 being electrically connected. Each of the through-hole conductors 59a to 59e includes a conductive material (e.g., Ag or Pd). Similarly to the plurality of coil conductors 53 to 58, each of the through-hole conductors 59a to 59e is formed as a sintered body of a conductive paste including a conductive material (e.g., an Ag powder or a Pd powder).

The coil conductor 53 is connected to the connecting conductor 51. The connecting conductor 51 is disposed on the end surface 2a side of the element body 2 and has an end portion that is exposed on the end surface 2a. The end portion of the connecting conductor 51 is exposed on the end surface 2a at a position closer to the main surface 2c and is connected to the electrode portion 4a of the external electrode 4. That is, the coil 3 is electrically connected to the external electrode 4 via the connecting conductor 51. In this embodiment, a conductive pattern of the coil conductor 53 and a conductive pattern of the connecting conductor 51 are continuously and integrally formed.

The coil conductor 53 has a first portion 53a extending in the first direction D1 on the side surface 2f side, a second portion 53b extending in the third direction D3 on the end surface 2b side, and a third portion 53c extending in the first direction D1 on the side surface 2e side. One end of the first portion 53a is connected to the connecting conductor 51. The other end of the first portion 53a is connected to one end of the second portion 53b. The other end of the second portion 53b is connected to one end of the third portion 53c. The other end of the third portion 53c is connected to a pad portion 53d provided in a central portion of the magnetic layer 11 in the first direction D1.

The coil conductor 54 has a first portion 54a extending in the first direction D1 on the side surface 2e side, a second portion 54b extending in the third direction D3 on the end surface 2a side, and a third portion 54c extending in the first direction D1 on the side surface 2f side. One end of the first portion 54a is connected to a pad portion 54d provided in the central portion of the magnetic layer 11 in the first direction D1. The pad portion 54d is provided at a position overlapping the pad portion 53d in the lamination direction and is connected to the pad portion 53d by the through-hole conductor 59a. The other end of the first portion 54a is connected to one end of the second portion 54b. The other end of the second portion 54b is connected to one end of the third portion 54c. The other end of the third portion 54c is connected to a pad portion 54e provided closer to the end surface 2b.

The coil conductor 55 has a first portion 55a extending in the third direction D3 on the end surface 2b side, a second portion 55b extending in the first direction D1 on the side surface 2e side, a third portion 55c extending in the third direction D3 on the end surface 2a side, and a fourth portion 55d extending in the first direction D1 on the side surface 2f side. One end of the first portion 55a is connected to a pad portion 55e provided closer to the end surface 2b. The pad portion 55e is provided at a position overlapping the pad portion 54e in the lamination direction and is connected to the pad portion 54e by the through-hole conductor 59b. The other end of the first portion 55a is connected to one end of the second portion 55b. The other end of the second portion 55b is connected to one end of the third portion 55c. The other end of the third portion 55c is connected to one end of the fourth portion 55d. The other end of the fourth portion 55d is connected to a pad portion 55f provided in the central portion of the magnetic layer 11 in the first direction D1.

The coil conductor 56 has a first portion 56a extending in the first direction D1 on the side surface 2f side, a second portion 56b extending in the third direction D3 on the end surface 2b side, and a third portion 56c extending in the first direction D1 on the side surface 2e side. One end of the first portion 56a is connected to a pad portion 56d provided in the central portion of the magnetic layer 11 in the first direction D1. The pad portion 56d is provided at a position overlapping the pad portion 55f in the lamination direction and is connected to the pad portion 55f by the through-hole conductor 59c. The other end of the first portion 56a is connected to one end of the second portion 56b. The other end of the second portion 56b is connected to one end of the third portion 56c. The other end of the third portion 56c is connected to a pad portion 56e provided closer to the end surface 2a.

The coil conductor 57 has a first portion 57a extending in the third direction D3 on the end surface 2a side, a second portion 57b extending in the first direction D1 on the side surface 2f side, a third portion 57c extending in the third direction D3 on the end surface 2b side, and a fourth portion 57d extending in the first direction D1 on the side surface 2e side. One end of the first portion 57a is connected to a pad portion 57e provided closer to the end surface 2a. The pad portion 57e is provided at a position overlapping the pad portion 56e in the lamination direction and is connected to the pad portion 56e by the through-hole conductor 59d. The other end of the first portion 57a is connected to one end of the second portion 57b. The other end of the second portion 57b is connected to one end of the third portion 57c. The other end of the third portion 57c is connected to one end of the fourth portion 57d. The other end of the fourth portion 57d is connected to a pad portion 57f provided in the central portion of the magnetic layer 11 in the first direction D1.

The coil conductor 58 has a first portion 58a extending in the first direction D1 on the side surface 2e side, a second portion 58b extending in the third direction D3 on the end surface 2a side, and a third portion 58c extending in the first direction D1 on the side surface 2f side. One end of the first portion 58a is connected to a pad portion 58d provided in the central portion of the magnetic layer 11 in the first direction D1. The pad portion 58d is provided at a position overlapping the pad portion 57f in the lamination direction and is connected to the pad portion 57f by the through-hole conductor 59e. The other end of the first portion 58a is connected to one end of the second portion 58b. The other end of the second portion 58b is connected to one end of the third portion 58c. The other end of the third portion 58c is connected to the connecting conductor 52.

The coil conductor 58 is connected to the connecting conductor 52. The connecting conductor 52 is disposed on the end surface 2b side of the element body 2 and has an end portion that is exposed on the end surface 2b. The end portion of the connecting conductor 52 is exposed on the end surface 2b at a position closer to the main surface 2d and is connected to the electrode portion 5a of the external electrode 5. That is, the coil 3 is electrically connected to the external electrode 5 via the connecting conductor 52. In this embodiment, a conductive pattern of the coil conductor 58 and a conductive pattern of the connecting conductor 52 are continuously and integrally formed. In the first direction D1, the connecting conductor 51 and the connecting conductor 52 have equivalent lengths.

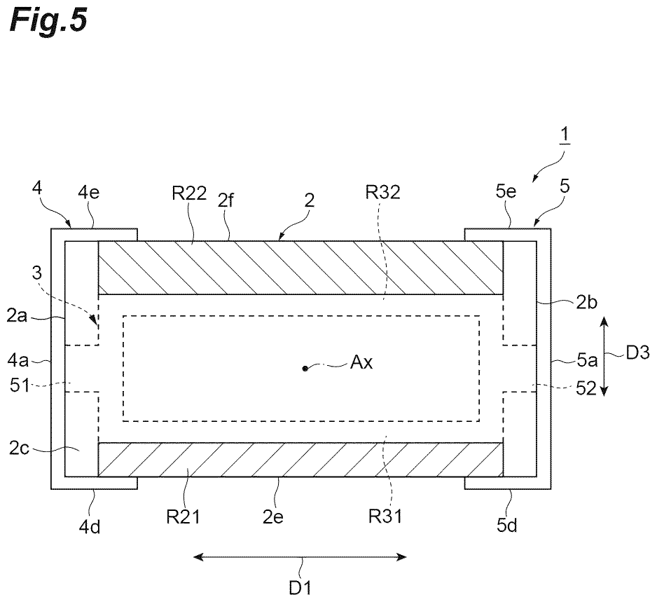

FIG. 5 is a plan view of the coil component of FIG. 1. The figure shows the coil component 1 as viewed from the main surface 2c side. In the figure, the electrode portion 4c and the electrode portion 5c are omitted in order to show the element body 2. The internal conductors are illustrated in broken lines. As illustrated in the figure, the coil 3 is generally shifted toward the side surface 2e in the third direction D3. That is, the coil 3 is disposed closer to the side surface 2e than to the side surface 2f. A distance between the coil 3 and the side surface 2e in the third direction D3 (length of an element body region R21 in the third direction D3) is shorter than a distance between the coil 3 and the side surface 2f in the third direction D3 (length of an element body region R22 in the third direction D3). The coil 3 is disposed at substantially equal distances from the end surface 2a and the end surface 2b.

The coil 3 has a coil region R31 and a coil region R32. The coil region R31 is a region that faces the side surface 2e in the third direction D3 and extends in the first direction D1 on the side of the coil axis Ax closer to the side surface 2e. The coil region R31 includes the third portion 53c of the coil conductor 53, the first portion 54a of the coil conductor 54, the second portion 55b of the coil conductor 55, the third portion 56c of the coil conductor 56, the fourth portion 57d of the coil conductor 57, and the first portion 58a of the coil conductor 58. The coil region R32 is a region that faces the side surface 2f in the third direction D3 and extends in the first direction D1 on the side of the coil axis Ax closer to the side surface 2f. The coil region R32 includes the first portion 53a of the coil conductor 53, the third portion 54c of the coil conductor 54, the fourth portion 55d of the coil conductor 55, the first portion 56a of the coil conductor 56, the second portion 57b of the coil conductor 57, and the third portion 58c of the coil conductor 58.

In the coil 3, the number of turns of the coil 3 in the coil region R31 is less than the number of turns of the coil 3 in the coil region R32. The number of turns of the coil 3 in the coil region R31 corresponds to the number of times that the coil 3 passes through the coil region R31, which is four in this case. The number of turns of the coil 3 in the coil region R32 corresponds to the number of times that the coil 3 passes through the coil region R32, which is five in this case.

The element body 2 has the element body region R21 and the element body region R22. The element body region R21 is located between the side surface 2e and the coil region R31 of the coil 3 in the third direction D3. The element body region R21 and the coil region R31 are adjacent to each other. The element body region R21 is disposed so as to connect the side surface 2e and the coil 3 when viewed in the second direction D2. The element body region R21 and the coil region R31 are in contact with each other. The element body region R21 includes at least a portion of the side surface 2e.

The element body region R22 is located between the side surface 2f and the coil region R32 of the coil 3 in the third direction D3. The element body region R22 and the coil region R32 are adjacent to each other. The element body region R22 is disposed so as to connect the side surface 2f and the coil 3 when viewed in the second direction D2. The element body region R22 and the coil region R32 are in contact with each other. The element body region R22 includes at least a portion of the side surface 2f.

An area of the coil 3 in contact with the element body region R21 is less than an area of the coil 3 in contact with the element body region R22. An area of the coil region R31 that overlaps the element body region R21 is less than an area of the coil region R32 that overlaps the element body region R22 when viewed in the third direction D3. The element body region R21 is shorter than the element body region R22 in the third direction D3.

In this embodiment, each of the element body region R21 and the element body region R22 has a length in the first direction D1 equivalent to the length of the coil 3 in the first direction D1. Each of the element body region R21 and the element body region R22 is disposed so as to overlap the entirety of the coil 3 when viewed in the third direction D3. That is, each of the element body region R21 and the element body region R22 is provided along the entire lengths of the coil 3 in both the first direction D1 and the second direction D2.

In the description of the embodiments, “equivalent” may refer to values that include minute differences or manufacturing errors within a preset range, in addition to meaning the same. For example, if a plurality of values are included in a ±5% range of an average value of the plurality of values, it is defined that the plurality of values are equivalent.

Each of the element body region R21 and the element body region R22 has a length in the first direction D1 less than a length of the element body 2 in the first direction D1. Both the element body region R21 and the element body region R22 are spaced apart from the end surface 2a and the end surface 2b. Each of the element body region R21 and the element body region R22 has a length in the second direction D2 equivalent to a length of the element body 2 in the second direction D2. The element body region R21 is provided along the entire length of the side surface 2e in the second direction D2. The element body region R22 is provided along the entire length of the side surface 2f in the second direction D2.

The element body region R21 includes the portion of each of the magnetic layers 11 on the side surface 2e side. The element body region R22 includes the portion of each of the magnetic layers 11 on the side surface 2f side. The element body region R21 includes, in addition to the side surface 2e, the portion of each of the main surface 2c and the main surface 2d on the side surface 2e side. The element body region R22 includes, in addition to the side surface 2f, the portion of each of the main surface 2c and the main surface 2d on the side surface 2f side.

The element body region R21 has a resistivity higher than a resistivity of the element body region R22. The portions of the element body 2 other than the element body region R21 and the element body region R22 have a resistivity, for example, equivalent to the resistivity of the element body region R22, but may have a different resistivity. As described above, the element body 2 has the plurality of metallic magnetic particles 6, the insulating films 7 that cover the surfaces of the plurality of metallic magnetic particles 6, and the resin 8 that is present between the plurality of metallic magnetic particles 6. In the element body 2, voids 9 between the plurality of metallic magnetic particles 6 in which the resin 8 is not present are present.

The proportion of the element body region R21 occupied by the voids 9 may be less than the proportion of the element body region R22 occupied by the voids 9. Additionally, the proportion of the element body region R21 occupied by the resin 8 may be greater than the proportion of the element body region R22 occupied by the resin 8. Furthermore, the proportion of the element body region R21 occupied by the insulating films 7 may be greater than the proportion of the element body region R22 occupied by the insulating films 7. The resistivity of the element body region R21 can be made higher than the resistivity of the element body region R22 by any of the above.

The plurality of metallic magnetic particles 6 in the element body region R21 may have an average particle size smaller than an average particle size of the plurality of metallic magnetic particles 6 in the element body region R22. This enables the proportion of the element body region R21 occupied by the insulating films 7 to be greater than the proportion of the element body region R22 occupied by the insulating films 7. As a result, the resistivity of the element body region R21 can be made higher than the resistivity of the element body region R22.

The “average particle size” in this embodiment is as described above. The average particle size of the metallic magnetic particles 6 in the element body region R21 is 0.5 μm or more and 10 μm or less. The average particle size of the metallic magnetic particles 6 in the element body region R22 is 1.0 μm or more and 20 μm or less.

A method for measuring the resistivity of the element body region R21 will be described. First, only the element body region R21 is removed from the coil component 1 by grinding. A pair of terminals is then attached to the element body region R21. A probe is brought into contact with the pair of terminals and the resistance is measured. The distance between the pair of terminals is measured and the resistivity is calculated. The resistivity of the element body region R22 can also be measured similarly by removing only the element body region R22 from the coil component 1. In the example of FIG. 5, a rectangular parallelepiped consisting solely of the element body region R21 at least in the central portion in the first direction D1 can be obtained by grinding the coil component 1 from the side surface 2e. The resistance of the element body region R21 may be measured by using the electrode portion 4d and the electrode portion 5d remaining at both end portions in the first direction D1 as the pair of terminals.

As described above, in the coil component 1, the element body region R21 has a resistivity higher than the resistivity of the element body region R22. The element body region R21 is located between the side surface 2e and the coil 3. Accordingly, the occurrence of a short circuit between the coil 3 and the electrode portion 4d and the electrode portion 5d disposed on the side surface 2e can be suppressed. In the coil component 1, the number of turns of the coil 3 in the coil region R31 is less than the number of turns of the coil 3 in the coil region R32. The difference in leakage magnetic flux caused by this difference in the number of turns is adjusted by disposing the coil 3 closer to the side surface 2e than to the side surface 2f.

In the coil component 1, the distance between the coil 3 and the side surface 2e is short. Additionally, the area of the coil 3 in contact with the element body region R21 is greater than the area of the coil 3 in contact with the element body region R22. Therefore, the configuration in which the element body region R21 having a high resistivity is located between the coil 3 and the side surface 2e is particularly effective.

### Second Embodiment

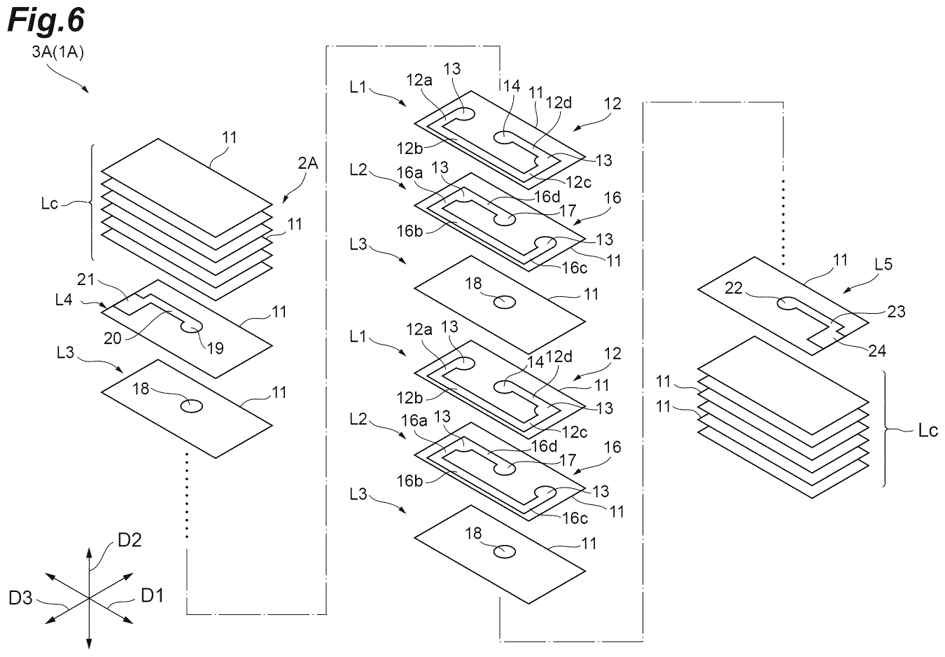

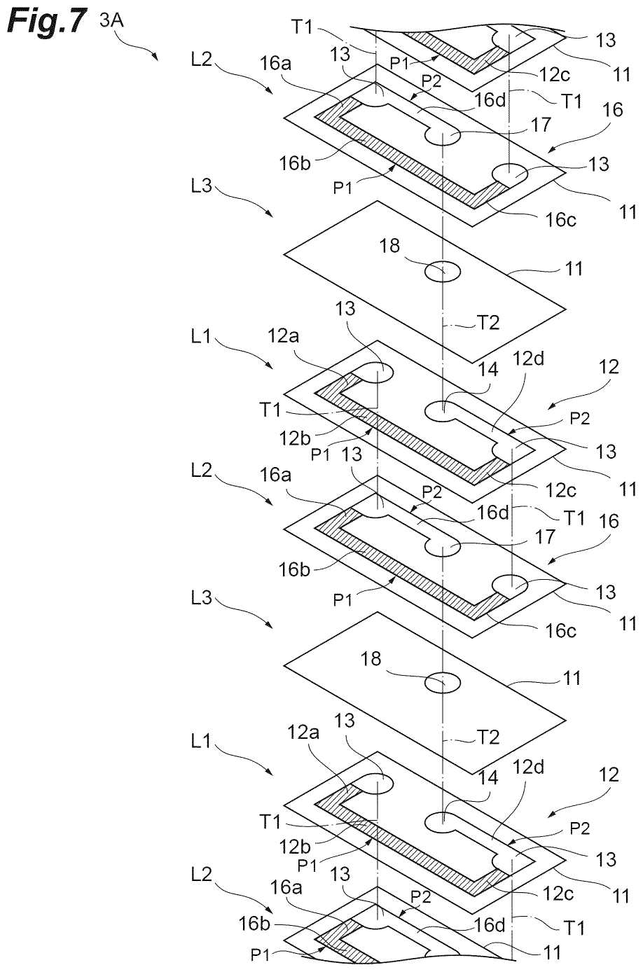

A coil component 1A according to a second embodiment will be described with reference to FIGS. 6 and 7. As illustrated in FIG. 6, the coil component 1A is different from the coil component 1 in the configuration of the internal conductors and in that it includes an element body 2A. The coil component 1A has, as the internal conductors disposed inside the element body 2A, a coil 3A, a connecting conductor 21, and a connecting conductor 24. The coil 3A is disposed inside the element body 2A and has the coil axis Ax perpendicular to the main surface 2c and the main surface 2d, similarly to the coil 3 (see FIGS. 2, 4, and 5). The element body 2A is different from the element body 2 in that it has a shape corresponding to the coil 3A.

A plurality of layers that form the coil 3A are composed including a cover layer Lc and conductive pattern layers L1, L2, L3, L4, L5. The cover layer Lc is a layer composed only of the magnetic layer 11 including metallic magnetic particles. A plurality of the cover layers Lc are disposed on each of the main surface 2c side and the main surface 2d side of the element body 2A.

In each of the layers excluding the cover layers Lc, a conductor portion (coil conductor layer) is formed in a predetermined pattern. The conductor portion is formed, for example, of a metal material. Although not particularly limited, for example, Ag, Cu, Au, Al, Pd, or a Pd/Ag alloy may be used for the metal material. A Ti compound, a Zr compound, a Si compound, or the like may be added to the metal material. For example, a printing method or a thin film deposition method may be used to form the conductor portion.

The conductive pattern layer L1 and the conductive pattern layer L2 are layers that form a main portion (winding portion) of the coil 3A. In this embodiment, the conductive pattern layer L1, the conductive pattern layer L2, and the conductive pattern layer L3 are laminated in this order, one layer at a time, to form one set. Inside the element body 2A, a plurality of the sets are provided in the laminate structure according to the required number of turns in the coil 3A.

The conductive pattern layer L1 has a conductive pattern 12 (coil conductor layer). The conductive pattern 12 has an overall substantially rectangular ring shape. The conductive pattern 12 has a first portion 12a extending in the third direction D3 on the end surface 2a side, a second portion 12b extending in the first direction D1 on the side surface 2e side, a third portion 12c extending in the third direction D3 on the end surface 2b side, and a fourth portion 12d extending in the first direction D1 on the side surface 2f side.

In the conductive pattern 12, one end of the fourth portion 12d is connected to an end portion of the third portion 12c on the side surface 2f side, and the other end of the fourth portion 12d is located in the center in the first direction D1 of the conductive pattern layer L1. A first pad portion 13 is provided at each of an end portion of the first portion 12a on the side surface 2f side and a connecting portion between the third portion 12c and the fourth portion 12d. Additionally, a second pad portion 14 is provided at the other end of the fourth portion 12d.

The conductive pattern layer L2 has a conductive pattern 16 (coil conductor layer). The conductive pattern 16 has an overall substantially rectangular ring shape. The conductive pattern 16 has a first portion 16a extending in the third direction D3 on the end surface 2a side, a second portion 16b extending in the first direction D1 on the side surface 2e side, and a third portion 16c extending in the third direction D3 on the end surface 2b side. Additionally, the conductive pattern 16 has a fourth portion 16d extending in the first direction D1 on the side surface 2f side.

In the conductive pattern 16, one end of the fourth portion 16d is connected to an end portion of the first portion 16a on the side surface 2f side, and the other end of the fourth portion 16d is located in the center in the first direction D1 of the conductive pattern layer L2. The first pad portion 13 is provided at each of a connecting portion between the first portion 16a and the fourth portion 16d and an end portion of the third portion 16c on the side surface 2f side. Additionally, a third pad portion 17 is provided at the other end of the fourth portion 16d.

In this embodiment, as described above, the other end of the fourth portion 12d at which the second pad portion 14 is provided in the conductive pattern 12 and the other end of the fourth portion 16d at which the third pad portion 17 is provided in the conductive pattern 16 are both located in the center in the first direction D1. Accordingly, the second pad portion 14 and the third pad portion 17 overlap each other in the lamination direction.

The conductive pattern layer L3 is a layer that functions to ensure spacing between the conductive pattern layer L1 and the conductive pattern layer L2 of adjacent sets in the lamination direction. The conductive pattern layer L3 has only a pad portion 18 as the conductor portion. The pad portion 18 is disposed corresponding to the second pad portion 14 of the conductive pattern 12 and the third pad portion 17 of the conductive pattern 16. That is, the pad portion 18, the second pad portion 14, and the third pad portion 17 overlap each other in the lamination direction.

The conductive pattern layer L4 is a layer that connects the coil 3A to the external electrode 4. The conductive pattern layer L4 is disposed on the main surface 2c side. On the main surface 2c side, a single layer of the conductive pattern layer L3 is disposed on an upper side (main surface 2c side) of the conductive pattern layer L1 of the set located closest to the main surface 2c. The conductive pattern layer L4 has a pad portion 19, a coil conductor 20, and the connecting conductor 21. The pad portion 19 is disposed so as to overlap the pad portion 18 of the conductive pattern layer L3 in the lamination direction. The pad portion 19 is electrically connected to the pad portion 18 via a through-hole (not shown). The coil conductor 20 extends in the first direction D1 from the pad portion 19 toward the connecting conductor 21. The connecting conductor 21 is provided at an edge portion on the end surface 2a side. The connecting conductor 21 is connected to the electrode portion 4a at the end surface 2a.

The conductive pattern layer L5 is a layer that connects the coil 3A to the external electrode 5. The conductive pattern layer L5 is disposed on the main surface 2d side. On the main surface 2d side, the conductive pattern layer L5 is disposed on a lower side (main surface 2d side) of the conductive pattern layer L3 of the set located closest to the main surface 2d. The conductive pattern layer L5 has a pad portion 22, a coil conductor 23, and the connecting conductor 24. The pad portion 22 is disposed so as to overlap the pad portion 18 of the conductive pattern layer L3 in the lamination direction. The pad portion 22 is electrically connected to the pad portion 18 via a through-hole (not shown). The coil conductor 23 extends in the first direction D1 from the pad portion 22 toward the connecting conductor 24. The connecting conductor 24 is provided at an edge portion on the end surface 2b side. The connecting conductor 24 is connected to the electrode portion 5a at the end surface 2b.

Next, the connection relationship between the conductive pattern layer L1 and the conductive pattern layer L2 described above will be described in further detail. FIG. 7 is a diagram illustrating the connection relationship of the conductive pattern layers. As illustrated in this figure, in connecting the conductive pattern layer L1 and the conductive pattern layer L2, each of the conductive pattern 12 and the conductive pattern 16 has a parallel portion P1 that overlaps the other in the lamination direction and a non-parallel portion P2 that does not overlap the other in the lamination direction.

In this embodiment, the first portions 12a, 16a, the second portions 12b, 16b, and the third portions 12c, 16c of the conductive pattern 12 and the conductive pattern 16 are the parallel portions P1, and the fourth portions 12d, 16d thereof are the non-parallel portions P2. In one set, the first pad portions 13, 13 provided at the parallel portion P1 of the conductive pattern 12 and the parallel portion P1 of the conductive pattern 16 are connected to each other via first through-holes T1. On the other hand, in the one set, the second pad portion 14 provided at the non-parallel portion P2 of the conductive pattern 12 and the third pad portion 17 provided at the non-parallel portion P2 of the conductive pattern 16 are not connected.

The second pad portion 14 and the third pad portion 17 are used for the connection between one set and a set adjacent to the one set in the lamination direction. In the example in FIG. 7, the second pad portion 14 provided at the non-parallel portion P2 of the conductive pattern 12 of one set and the third pad portion 17 provided at the non-parallel portion P2 of the conductive pattern 16 of a set located on one side of the one set in the lamination direction are connected to each other via the pad portion 18 of the conductive pattern layer L3 and a second through-hole T2. The third pad portion 17 provided at the non-parallel portion P2 of the conductive pattern 16 of the one set and the second pad portion 14 provided at the non-parallel portion P2 of the conductive pattern 12 of a set located on the other side of the one set in the lamination direction are connected to each other via the pad portion 18 of the conductive pattern layer L3 and the second through-hole T2.

Similarly to the coil 3 (see FIG. 5), the coil 3A is generally shifted toward the side surface 2e in the third direction D3. That is, the coil 3A is disposed closer to the side surface 2e than to the side surface 2f. A distance between the coil 3A and the side surface 2e in the third direction D3 is shorter than a distance between the coil 3A and the side surface 2f in the third direction D3. The coil 3A is disposed at substantially equal distances from the end surface 2a and the end surface 2b.

In the coil 3A, the coil region R31 (see FIG. 5) includes the second portion 12b of the conductive pattern 12 and the second portion 16b of the conductive pattern 16. The coil region R32 (see FIG. 5) includes the fourth portion 12d of the conductive pattern 12 and the fourth portion 16d of the conductive pattern 16.

As described above, the number of turns of the coil 3A in the coil region R31 corresponds to the number of times that the coil 3A passes through the coil region R31. Since the parallel portion P1 of the conductive pattern 12 and the parallel portion P1 of the conductive pattern 16 in one set are connected to each other via the first through-holes T1 and have almost no potential difference, they are counted as one conductive pattern for the number of turns. Accordingly, the number of turns of the coil 3A in the coil region R31 is two. The number of turns of the coil 3A in the coil region R32 corresponds to the number of times that the coil 3A passes through the coil region R32, which is three in this case. Therefore, the number of turns of the coil 3A in the coil region R31 is less than the number of turns of the coil 3A in the coil region R32, also in the coil 3A.

Similarly to the element body 2, the element body 2A has the element body region R21 and the element body region R22. The element body region R21 includes the portion of each of the cover layers Lc and the conductive pattern layers L1, L2, L3, L4, L5 on the side surface 2e side. The element body region R22 includes the portion of each of the cover layers Lc and the conductive pattern layers L1, L2, L3, L4, L5 on the side surface 2f side. The element body region R21 includes, in addition to the side surface 2e, the portion of each of the main surface 2c and the main surface 2d on the side surface 2e side. The element body region R22 includes, in addition to the side surface 2f, the portion of each of the main surface 2c and the main surface 2d on the side surface 2f side.

In the coil component 1A, the element body region R21 also has a resistivity higher than the resistivity of the element body region R22. The portions of the element body 2A other than the element body region R21 and the element body region R22 have a resistivity, for example, equivalent to the resistivity of the element body region R22, but may have a different resistivity.

As described above, in the coil component 1A, the element body region R21 also has a resistivity higher than the resistivity of the element body region R22. Additionally, the number of turns of the coil 3A in the coil region R31 is less than the number of turns of the coil 3A in the coil region R32. Furthermore, the distance between the coil 3A and the side surface 2e is short. Furthermore, an area of the coil 3A in contact with the element body region R21 is greater than an area of the coil 3A in contact with the element body region R22. Therefore, effects similar to those of the coil component 1 can also be obtained in the coil component 1A.

In the coil region R31, the second portions 12b, 16b which are the parallel portions P1 are disposed in parallel connection. On the other hand, in the coil region R32, the fourth portions 12d, 16d which are the non-parallel portions P2 are disposed in series connection. If the resistance of each of the second portions 12b, 16b is R and the current that flows through each of the second portions 12b, 16b is I, the resistance of each of the fourth portions 12d, 16d is 2R and the current that flows through each of the fourth portions 12d, 16d is 2I. Accordingly, the voltage applied to the coil region R31 is IR and the voltage applied to the coil region R32 is 4IR. Since the capacitance of the coil region R32 is large, the configuration in which the element body region R22 is longer than the element body region R21 in the third direction D3 is effective for suppressing the occurrence of a short circuit.

### Third Embodiment

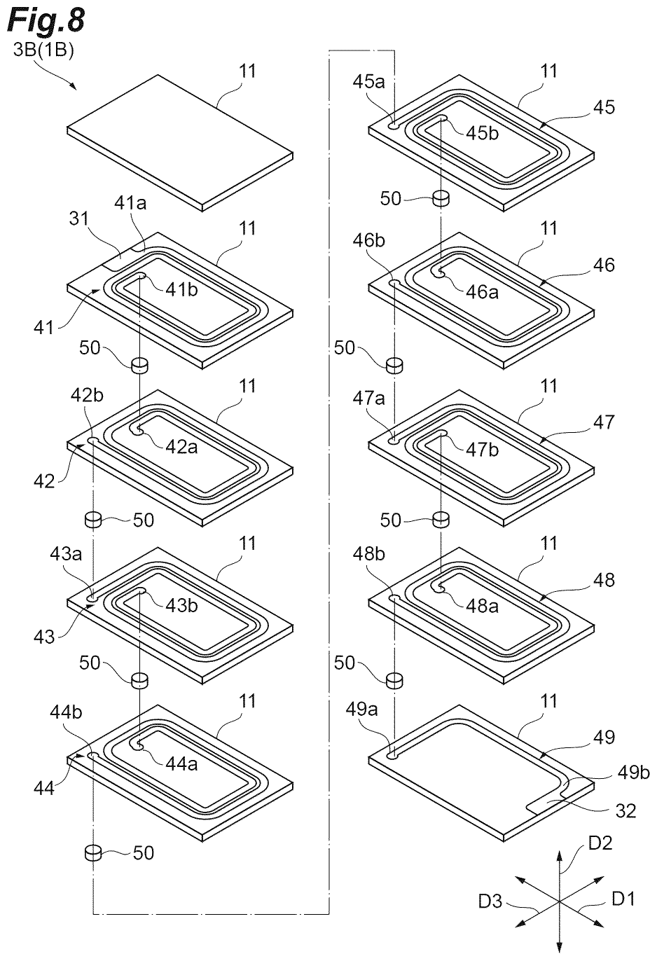

A coil component 1B according to a third embodiment will be described with reference to FIGS. 8 to 10. As illustrated in FIG. 8, the coil component 1B is different from the coil component 1 in the configuration of the internal conductors and in that it includes an element body 2B. The coil component 1B has, as the internal conductors disposed inside the element body 2B, a coil 3B, a connecting conductor 31, and a connecting conductor 32. The coil 3B is disposed inside the element body 2B and has the coil axis Ax perpendicular to the main surface 2c and the main surface 2d, similarly to the coil 3 (see FIGS. 2, 4, and 5). The coil 3B includes a plurality of coil conductors C. In this embodiment, the coil 3B includes nine coil conductors 41 to 49. The coil 3B further includes through-hole conductors 50.

The coil conductors C (coil conductors 41 to 49) are disposed inside the element body 2B. Each of the coil conductors C has a thickness of, for example, about 5 to 300 μm. The coil conductors 41 to 49 are spaced apart from each other in the second direction D2. The distances between the coil conductors 41 to 49 adjacent to each other in the second direction D2 are equivalent, but may be different. The distance between the coil conductors 41 to 49 is, for example, 5 to 30 μm, and is 15 μm in this embodiment.

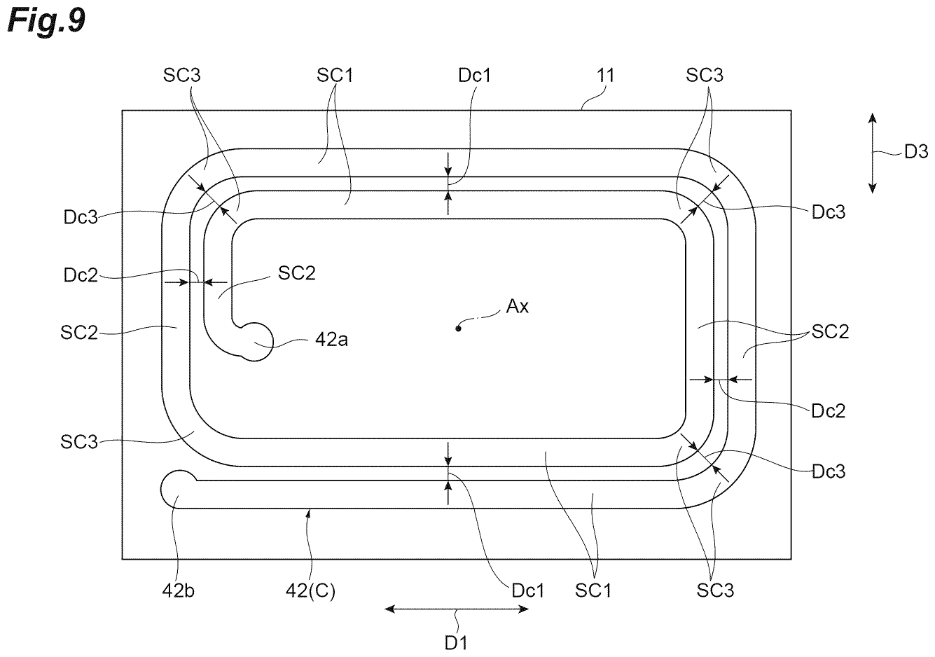

FIG. 9 is a plan view of a coil conductor. The coil conductor 42 is illustrated in this figure. The coil conductors 41 to 48 among the plurality of coil conductors C will first be described. As illustrated in FIGS. 8 and 9, the coil conductors 41 to 48 have a spiral (helical) shape when viewed in the second direction D2 (direction along the coil axis Ax). The coil conductors 41 to 48 have a plurality of first conductor portions SC1, a plurality of second conductor portions SC2, and a plurality of third conductor portions SC3.

The plurality of first conductor portions SC1 extend along the first direction D1 on each of the side surface 2e side and the side surface 2f side. The plurality of first conductor portions SC1 on the side surface 2e side and the plurality of first conductor portions SC1 on the side surface 2f side face each other in the third direction D3 with the coil axis Ax interposed therebetween. The plurality of second conductor portions SC2 extend along the third direction D3 on each of the end surface 2a side and the end surface 2b side. The plurality of second conductor portions SC2 on the end surface 2a side and the plurality of second conductor portions SC2 on the end surface 2b side face each other in the first direction D1 with the coil axis Ax interposed therebetween.

The second conductor portions SC2 are shorter than the first conductor portions SC1. In other words, the first conductor portions SC1 are longer than the second conductor portions SC2. The third conductor portions SC3 form corner portions of the coil conductor C. The third conductor portions SC3 have a curved shape. The third conductor portions SC3 have a predetermined curvature. In the third conductor portions SC3, outer side surfaces and inner side surfaces are parallel to each other. That is, in the third conductor portions SC3, the curvature of the outer side surfaces and the curvature of the inner side surfaces are different. The first conductor portions SC1, the second conductor portions SC2, and the third conductor portions SC3 have a width of, for example, about 5 to 300 μm.

A first distance Dc1 between the first conductor portions SC1 disposed on the side surface 2e side or the side surface 2f side and adjacent to each other in the third direction D3 and a second distance Dc2 between the second conductor portions SC2 disposed on the end surface 2a side or the end surface 2b side and adjacent to each other in the first direction D1 are equivalent (Dc1≈Dc2). The first distance Dc1 and the second distance Dc2 may be different. A third distance Dc3 between the third conductor portions SC3 adjacent to each other when viewed in the second direction D2 is greater than the first distance Dc1 and the second distance Dc2 (Dc3>Dc1, Dc2). The first distance Dc1 and the second distance Dc2 are, for example, 5 to 30 μm. In this embodiment, the first distance Dc1 and the second distance Dc2 are 10 μm. The third distance Dc3 is, for example, 8 to 50 μm. In this embodiment, the third distance Dc3 is 15 μm.

The coil conductor 42, the coil conductor 44, the coil conductor 46, and the coil conductor 48 have the same shape. The coil conductor 41 and the coil conductor 43 have a similar shape. They are different in that an end portion 43a of the coil conductor 43 is located closer to the side surface 2e than is an end portion 41a of the coil conductor 41. The coil conductor 43, the coil conductor 45, and the coil conductor 47 have the same shape.

The coil conductor 49 will next be described. The coil conductor 49 is substantially L-shaped when viewed in the second direction D2. The coil conductor 49 has one first conductor portion SC1, one second conductor portion SC2, and two third conductor portions SC3. The coil conductor 49 may be substantially U- or C-shaped when viewed in the second direction D2 and may have one first conductor portion SC1, two second conductor portions SC2, and two third conductor portions SC3. The first conductor portion SC1 of the coil conductor 49 is disposed on the side of the coil axis Ax closer to the side surface 2f.

The through-hole conductors 50 are located between end portions of the coil conductors 41 to 49 that are adjacent to each other in the second direction D2. The through-hole conductors 50 connect the end portions of the coil conductors 41 to 49 that are adjacent to each other in the second direction D2. The coil conductors 41 to 49 are electrically connected to each other through the through-hole conductors 50. The end portion of the coil conductor 41 forms one end of the coil 3B. The end portion of the coil conductor 49 forms the other end of the coil 3B.

The through-hole conductor 50 connects an end portion 41b of the coil conductor 41 and an end portion 42a of the coil conductor 42. The through-hole conductor 50 connects an end portion 42b of the coil conductor 42 and the end portion 43a of the coil conductor 43. The through-hole conductor 50 connects an end portion 43b of the coil conductor 43 and an end portion 44a of the coil conductor 44. The through-hole conductor 50 connects an end portion 44b of the coil conductor 44 and an end portion 45a of the coil conductor 45. The through-hole conductor 50 connects an end portion 45b of the coil conductor 45 and an end portion 46a of the coil conductor 46. The through-hole conductor 50 connects an end portion 46b of the coil conductor 46 and an end portion 47a of the coil conductor 47. The through-hole conductor 50 connects an end portion 47b of the coil conductor 47 and an end portion 48a of the coil conductor 48. The through-hole conductor 50 connects an end portion 48b of the coil conductor 48 and an end portion 49a of the coil conductor 49.

The connecting conductor 31 is connected to the coil conductor 41. The connecting conductor 31 is continuous with the coil conductor 41. The connecting conductor 31 is formed integrally with the coil conductor 41. The connecting conductor 31 connects the end portion 41a of the coil conductor 41 and the external electrode 4 and is exposed on the end surface 2a of the element body 2B. The connecting conductor 31 is connected to the electrode portion 4a. The connecting conductor 31 electrically connects one end portion of the coil 3B and the external electrode 4.

The connecting conductor 32 is connected to the coil conductor 49. The connecting conductor 32 is continuous with the coil conductor 49. The connecting conductor 32 is formed integrally with the coil conductor 49. The connecting conductor 32 connects an end portion 49b of the coil conductor 49 and the external electrode 5 and is exposed on the end surface 2b of the element body 2B. The connecting conductor 32 is connected to the electrode portion 5a. The connecting conductor 32 electrically connects the other end portion of the coil 3B and the external electrode 5.

The coil conductors C and the connecting conductors 31, 32 include a conductive material. The conductive material is, for example, Ag, Pd, Cu, Al, or Ni. The through-hole conductors 50 include a conductive material. The conductive material is, for example, Ag, Pd, Cu, Al, or Ni. The through-hole conductors 50 are formed as sintered bodies of a conductive paste. The conductive paste includes a conductive metal powder. The conductive metal powder is, for example, an Ag powder, a Pd powder, a Cu powder, an Al powder, or a Ni powder.

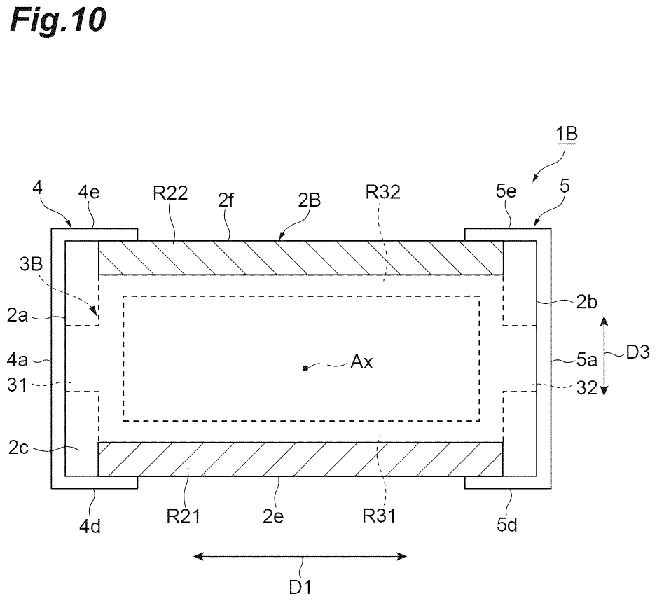

FIG. 10 is a plan view of the coil component illustrated in FIG. 8. The figure shows the coil component 1B as viewed from the main surface 2c side. As illustrated in this figure, the coil 3B is disposed at substantially equal distances from the side surface 2e and the side surface 2f. The coil 3B is disposed at substantially equal distances from the end surface 2a and the end surface 2b. Similarly to the coil 3, the coil 3B has the coil region R31 and the coil region R32. In the coil 3B, the coil region R31 includes the first conductor portions SC1 on the side surface 2e side, and the coil region R32 includes the first conductor portions SC1 on the side surface 2f side.

In the coil 3B, the coil conductors 41 to 48 have the first conductor portions SC1 on each of the side surface 2e side and the side surface 2f side, whereas the coil conductor 49 has the first conductor portion SC1 only on the side surface 2f side. Accordingly, the number of turns of the coil 3B in the coil region R32 is greater than the number of turns of the coil 3B in the coil region R31. Therefore, the probability of occurrence of a short circuit between the coil 3B and the electrode portion 4e or the electrode portion 5e is higher than the probability of occurrence of a short circuit between the coil 3B and the electrode portion 4d or the electrode portion 5d.

In this embodiment, the “number of turns” of the spiral coil conductors 41 to 48 may correspond to the number of turns counted by the outermost portions (outermost turns) at which the stray capacitance tends to increase between the external electrodes 4, 5. In this case, the number of turns of the coil 3B in the coil region R31 is counted by the conductor portions closest to the side surface 2e, and is four. The number of turns of the coil 3B in the coil region R32 is counted by the conductor portions closest to the side surface 2f, and is five.

The coil component 1B is also different from the coil component 1 in that it includes the element body 2B as mentioned above. The element body 2B is different from the element body 2 in that the element body region R21 and the element body region R22 have equivalent lengths in the third direction D3 and in that the element body region R22 (first element body region) has a resistivity higher than the resistivity of the element body region R21 (second element body region). Accordingly, even though the number of turns of the coil 3B in the coil region R32 is greater than the number of turns of the coil 3B in the coil region R31, the occurrence of a short circuit between the coil 3B and the electrode portion 4e or the electrode portion 5e can be suppressed.

In the element body 2B, the proportion of the element body region R22 occupied by the voids 9 is less than the proportion of the element body region R21 occupied by the voids 9. Additionally, the proportion of the element body region R22 occupied by the resin 8 is greater than the proportion of the element body region R21 occupied by the resin 8. Furthermore, the proportion of the element body region R22 occupied by the insulating films 7 is greater than the proportion of the element body region R21 occupied by the insulating films 7. Furthermore, the plurality of metallic magnetic particles 6 in the element body region R22 have an average particle size smaller than an average particle size of the plurality of metallic magnetic particles 6 in the element body region R21. The resistivity of the element body region R22 can be made higher than the resistivity of the element body region R21 by any of the above.

As described above, in the coil component 1B, the element body region R22 has a resistivity higher than the resistivity of the element body region R21. The element body region R22 is located between the side surface 2f and the coil 3B. Accordingly, the occurrence of a short circuit between the coil 3B and the electrode portion 4e and the electrode portion 5e disposed on the side surface 2f can be suppressed. In particular, in the coil component 1B, the number of turns of the coil 3B in the coil region R32 is greater than the number of turns of the coil 3B in the coil region R31. Additionally, an area of the coil 3B in contact with the element body region R22 is greater than an area of the coil 3B in contact with the element body region R21. Therefore, the configuration in which the element body region R22 having a high resistivity is located between the coil 3B and the side surface 2f is especially effective.

### Fourth Embodiment

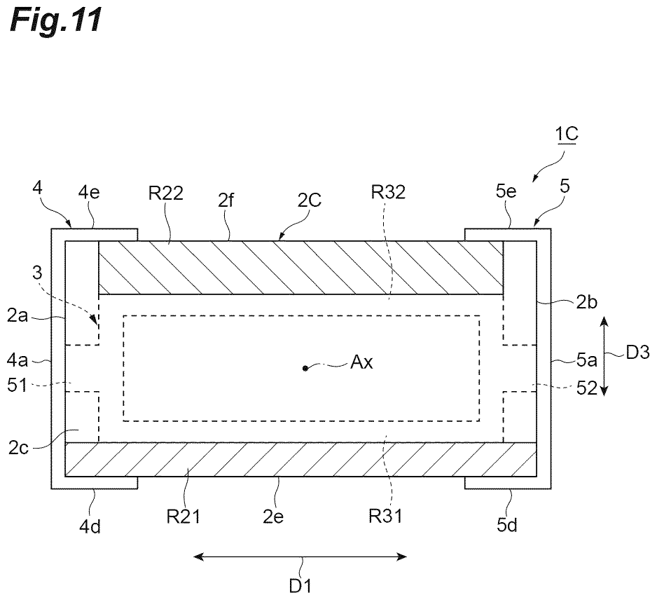

A coil component 1C according to a fourth embodiment will be described with reference to FIG. 11. As illustrated in this figure, the coil component 1C is different from the coil component 1 in that it includes an element body 2C. The element body 2C is different from the element body 2 in the shape of the element body region R21. The element body region R21 has a length in the first direction D1 equivalent to a length of the element body 2C in the first direction D1. That is, the element body region R21 is provided over the entirety of the side surface 2e. The element body region R21 includes the entirety of the side surface 2e and the portion of each of the main surface 2c, the main surface 2d, the end surface 2a, and the end surface 2b on the side surface 2e side.

In the coil component 1C, since the element body region R21 having a high resistivity is provided along the entire length in the first direction D1 of the portion of the element body 2C on the side surface 2e side, the occurrence of a short circuit between the coil 3 and the electrode portion 4d or the electrode portion 5d can further be suppressed.

### Fifth Embodiment

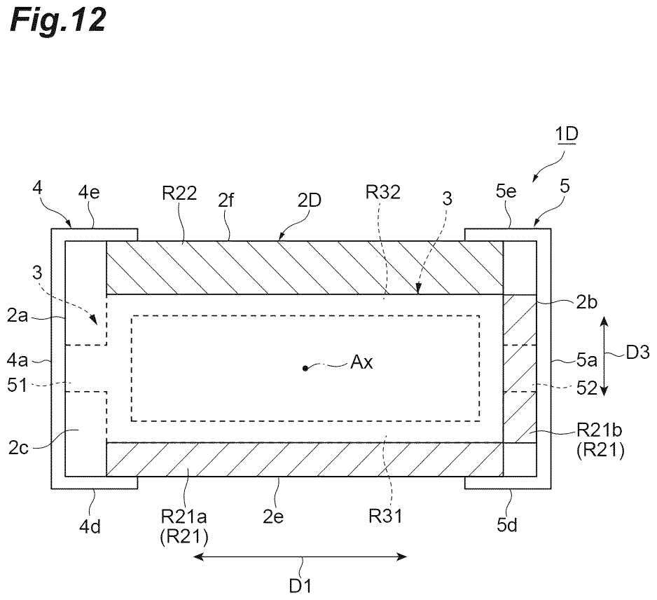

A coil component 1D according to a fifth embodiment will be described with reference to FIG. 12. As illustrated in this figure, the coil component 1D is different from the coil component 1 in the configuration of the internal conductors. In the coil component 1D, not only is the coil 3 generally shifted toward the side surface 2e in the third direction D3, but it is also shifted toward the end surface 2b in the first direction D1. That is, the coil 3 is disposed closer to the side surface 2e than to the side surface 2f and is disposed closer to the end surface 2b than to the end surface 2a. A distance between the coil 3 and the end surface 2b in the first direction D1 is shorter than a distance between the coil 3 and the end surface 2a in the first direction D1. In the first direction D1, the connecting conductor 51 is longer than the connecting conductor 52.

The coil component 1D is also different from the coil component 1 in that it includes an element body 2D. The element body region R21 of the element body 2D has a region portion R21a located between the coil 3 and the side surface 2e and a region portion R21b located between the coil 3 and the end surface 2b. In this example, the region portion R21a and the region portion R21b are in contact with each other at a corner portion of the coil 3, but they need not be in contact.

The region portion R21a has the same configuration as the element body region R21 of the element body 2. The region portion R21b has a length in the third direction D3 equivalent to the length of the coil 3 in the third direction D3. The region portion R21b is disposed so as to overlap the entirety of the coil 3 when viewed in the first direction D1. That is, the region portion R21b is provided along the entire lengths of the coil 3 in both the second direction D2 and the third direction D3. The region portion R21b has a length in the second direction D2 equivalent to a length of the element body 2D in the second direction D2.

The region portion R21b includes the portion of each of the magnetic layers 11 on the end surface 2b side. The region portion R21b includes, in addition to the end surface 2b, the portion of each of the main surface 2c and the main surface 2d on the end surface 2b side. The region portion R21b includes at least a portion of the end surface 2b.

Similarly to the coil component 1, in the coil component 1D, the region portion R21a has a resistivity higher than the resistivity of the element body region R22. Accordingly, the occurrence of a short circuit between the coil 3 and the electrode portion 4d and the electrode portion 5d disposed on the side surface 2e can be suppressed. In the coil component 1D, the region portion R21b has a resistivity higher than the resistivity of the element body region R22. Accordingly, the occurrence of a short circuit between the coil 3 and the electrode portion 5a can be suppressed.

### Sixth Embodiment

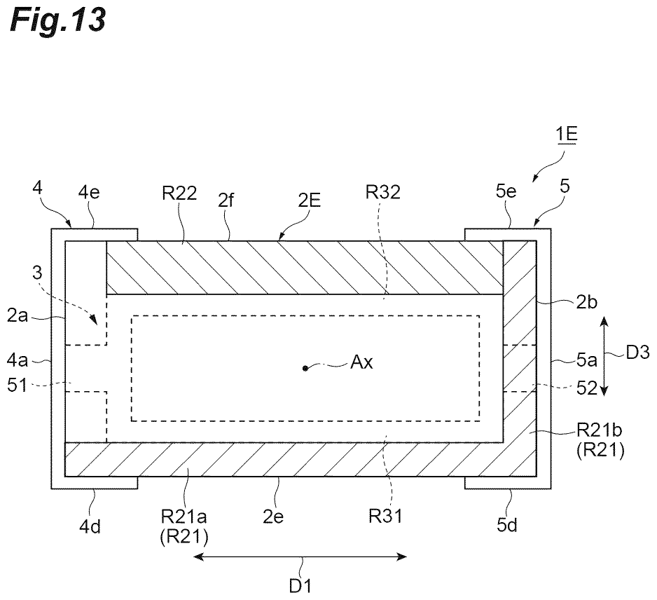

A coil component 1E according to a sixth embodiment will be described with reference to FIG. 13. As illustrated in this figure, the coil component 1E is different from the coil component 1 in the configuration of the internal conductors. The configuration of the internal conductors of the coil component 1E is the same as the configuration of the internal conductors of the coil component 1D. The coil component 1E is also different from the coil component 1 in that it includes an element body 2E. The element body region R21 of the element body 2E has the region portion R21a located between the coil 3 and the side surface 2e and the region portion R21b located between the coil 3 and the end surface 2b. In this example, the region portion R21a and the region portion R21b are connected to each other at a corner portion between the end surface 2b and the side surface 2e.

The region portion R21a is different from the element body region R21 of the element body 2 in the following points. The region portion R21a has lengths equivalent to those of the element body 2E in both the first direction D1 and the second direction D2. The region portion R21a is provided over the entirety of the side surface 2e. The region portion R21a includes, in addition to the side surface 2e, the portion of each of the end surface 2a, the end surface 2b, the main surface 2c, and the main surface 2d on the side surface 2e side.

The region portion R21b has lengths equivalent to those of the element body 2E in both the second direction D2 and the third direction D3. The region portion R21b is provided over the entirety of the end surface 2b. The region portion R21b is disposed so as to overlap the entirety of the coil 3 when viewed in the first direction D1. The region portion R21b includes, in addition to the end surface 2b, the portion of each of the main surface 2c, the main surface 2d, the side surface 2e, and the side surface 2f on the end surface 2b side.

Similarly to the coil component 1, in the coil component 1E, the region portion R21a has a resistivity higher than the resistivity of the element body region R22. Accordingly, the occurrence of a short circuit between the coil 3 and the electrode portion 4d and the electrode portion 5d disposed on the side surface 2e can be suppressed. In the coil component 1E, the region portion R21b has a resistivity higher than the resistivity of the element body region R22. Accordingly, the occurrence of a short circuit between the coil 3 and the electrode portion 5a disposed on the end surface 2b can be suppressed.

In the coil component 1E, since the element body region R21 having a high resistivity is provided over the entirety of each of the side surface 2e and the end surface 2b, the occurrence of a short circuit between the coil 3 and the electrode portion 4d, the electrode portion 5d, or the electrode portion 5a can further be suppressed.

### Seventh Embodiment

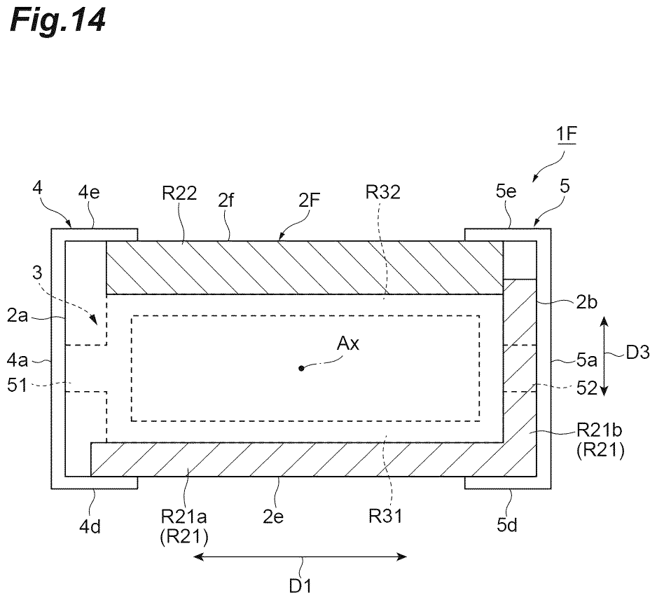

A coil component 1F according to a seventh embodiment will be described with reference to FIG. 14. As illustrated in this figure, the coil component 1F is different from the coil component 1 in the configuration of the internal conductors. The configuration of the internal conductors of the coil component 1F is the same as the configuration of the internal conductors of the coil component 1D. The coil component 1F is also different from the coil component 1 in that it includes an element body 2F. The element body region R21 of the element body 2F has the region portion R21a located between the coil 3 and the side surface 2e and the region portion R21b located between the coil 3 and the end surface 2b. In this example, the region portion R21a and the region portion R21b are connected to each other at a corner portion between the end surface 2b and the side surface 2e.

The region portion R21a is different from the element body region R21 of the element body 2 in the following points. The region portion R21a has a length greater than a length of the coil 3 and less than a length the element body 2F in the first direction D1. The region portion R21a is provided spaced apart from the end surface 2a in the first direction D1. An end portion of the region portion R21a on the end surface 2a side is located closer to the end surface 2a than is the coil 3 in the first direction D1. The region portion R21a includes, in addition to the side surface 2e, the portion of each of the end surface 2b, the main surface 2c, and the main surface 2d on the side surface 2e side.

The region portion R21b has a length greater than a length of the coil 3 and less than a length of the element body 2F in the third direction D3. The region portion R21b is provided spaced apart from the side surface 2f in the third direction D3. An end portion of the region portion R21b on the side surface 2f side is located closer to the side surface 2f than is the coil 3 in the third direction D3. The region portion R21b is disposed so as to overlap the entirety of the coil 3 when viewed in the first direction D1. The region portion R21b includes, in addition to the end surface 2b, the portion of each of the main surface 2c, the main surface 2d, and the side surface 2e on the end surface 2b side.

Similarly to the coil component 1, in the coil component 1F, the region portion R21a has a resistivity higher than the resistivity of the element body region R22. Accordingly, the occurrence of a short circuit between the coil 3 and the electrode portion 4d and the electrode portion 5d disposed on the side surface 2e can be suppressed. In the coil component 1F, the region portion R21b has a resistivity higher than the resistivity of the element body region R22. Accordingly, the occurrence of a short circuit between the coil 3 and the electrode portion 5a can be suppressed.

In the coil component 1F, the region portion R21a is provided to reach the end surface 2b and the region portion R21b is provided to reach the side surface 2e. Additionally, the end portion of the region portion R21a on the end surface 2a side is located closer to the end surface 2a than is the coil 3 in the first direction D1. Accordingly, the occurrence of a short circuit between the coil 3 and the electrode portion 4d or the electrode portion 5d can be reliably suppressed. Furthermore, the end portion of the region portion R21b on the side surface 2f side is located closer to the side surface 2f than is the coil 3 in the third direction D3. Accordingly, the occurrence of a short circuit between the coil 3 and the electrode portion 5a can be reliably suppressed.

### Eighth Embodiment

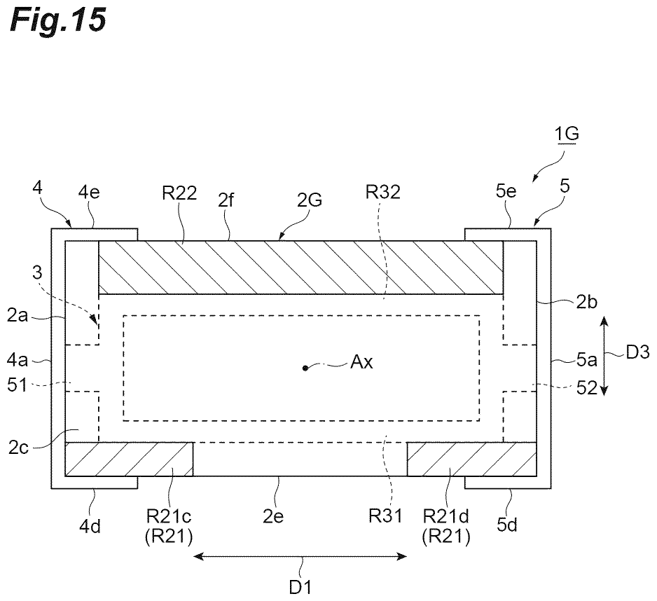

A coil component 1G according to an eighth embodiment will be described with reference to FIG. 15. As illustrated in this figure, the coil component 1G is different from the coil component 1 in that it includes an element body 2G. The element body 2G is different from the element body 2 in the shape of the element body region R21. In the element body 2G, the element body region R21 has a region portion R21c and a region portion R21d which are spaced apart from each other in the first direction D1. Between the side surface 2e and the coil 3, the region portion R21c is disposed closer to the end surface 2a and the region portion R21d is disposed closer to the end surface 2b. The region portion R21c includes the portion of the side surface 2e on the end surface 2a side and the portion of each of the end surface 2a, the main surface 2c, and the main surface 2d on the end surface 2a side and the side surface 2e side. The region portion R21d includes the portion of the side surface 2e on the end surface 2b side and the portion of each of the end surface 2b, the main surface 2c, and the main surface 2d on the end surface 2b side and the side surface 2e side.

The region portion R21c extends in the first direction D1 to a position exposed from the external electrode 4. The region portion R21d extends in the first direction D1 to a position exposed from the external electrode 5. The element body region R21 does not overlap the central portion of the coil 3 in the first direction D1 when viewed in the third direction D3.

Similarly to the coil component 1, in the coil component 1G, each of the region portion R21c and the region portion R21d has a resistivity higher than the resistivity of the element body region R22. Since the region portion R21c is disposed between the coil 3 and the electrode portion 4d, the occurrence of a short circuit between the coil 3 and the electrode portion 4d can be suppressed. Since the region portion R21d is disposed between the coil 3 and the electrode portion 5d, the occurrence of a short circuit between the coil 3 and the electrode portion 5d can be suppressed.

Although the embodiments have been described above, the present invention is not necessarily limited to these embodiments, and various modifications are possible without departing from the gist thereof.

For example, it is only required that the element body region R21 overlaps the coils 3, 3A, 3B when viewed in the third direction D3. Since the coils 3, 3A, 3B are shorter than the element bodies 2, 2A, 2B, 2C, 2D, 2E, 2F, 2G in the second direction D2, the element body region R21 may have a length greater than the lengths of the coils 3, 3A, 3B and less than the lengths of the element bodies 2, 2A, 2B, 2C, 2D, 2E, 2F, 2G. In this case, the element body region R21 does not include the main surface 2c and the main surface 2d. For example, the magnetic layer 11 that forms the outermost layer in the lamination direction (i.e., the magnetic layer 11 having the main surface 2c or the main surface 2d) need not be provided with the element body region R21. In the coil component 1A, only the conductive pattern layers L1, L2, L3, L4, L5 may have the element body region R21, and the cover layers Lc need not have the element body region R21.

The embodiments and variations described above may be combined as appropriate.

What is claimed is:

1. A coil component, comprising:
an element body including a main surface, and a first side surface and a second side surface facing each other in a direction along the main surface;
a coil disposed inside the element body and including a coil axis perpendicular to the main surface; and
an external electrode disposed at least on the first side surface,
wherein the element body includes:
a first element body region located between the first side surface and the coil in the direction; and
a second element body region located between the second side surface and the coil in the direction, and
wherein the first element body region has a resistivity higher than a resistivity of the second element body region.

2. The coil component according to claim 1,
wherein the element body includes a plurality of metallic magnetic particles and a resin present between the plurality of metallic magnetic particles, and
wherein a proportion of the first element body region occupied by voids between the plurality of metallic magnetic particles in which the resin is not present is less than a proportion of the second element body region occupied by the voids.

3. The coil component according to claim 1,
wherein the element body includes a plurality of metallic magnetic particles and a resin present between the plurality of metallic magnetic particles, and
wherein a proportion of the first element body region occupied by the resin is greater than a proportion of the second element body region occupied by the resin.

4. The coil component according to claim 1,
wherein the element body includes a plurality of metallic magnetic particles, insulating films covering surfaces of the plurality of metallic magnetic particles, and a resin present between the plurality of metallic magnetic particles, and
wherein a proportion of the first element body region occupied by the insulating films is greater than a proportion of the second element body region occupied by the insulating films.

5. The coil component according to claim 4, wherein the plurality of metallic magnetic particles in the first element body region have an average particle size smaller than an average particle size of the plurality of metallic magnetic particles in the second element body region.

6. The coil component according to claim 1, wherein the first element body region is shorter than the second element body region in the direction.

7. The coil component according to claim 1,
wherein the coil includes a first coil region adjacent to the first element body region and a second coil region adjacent to the second element body region, and
wherein a number of turns of the coil in the first coil region is less than a number of turns of the coil in the second coil region.

8. The coil component according to claim 1,
wherein the coil includes a first coil region adjacent to the first element body region and a second coil region adjacent to the second element body region, and
wherein an area of the coil in contact with the first element body region is greater than an area of the coil in contact with the second element body region.

9. The coil component according to claim 1, wherein the first element body region has a length equivalent to a length of the element body in a first direction perpendicular to each of the direction and the coil axis.

10. The coil component according to claim 1,
wherein the element body further includes a third side surface adjacent to each of the main surface, the first side surface, and the second side surface,
wherein the external electrode includes a first electrode portion disposed on the first side surface and a second electrode portion disposed on the third side surface, and
wherein the first element body region includes a first region portion located between the first side surface and the coil and a second region portion located between the third side surface and the coil.

11. A coil component, comprising:
an element body including a main surface, a first side surface and a second side surface facing each other in a direction along the main surface, and a third side surface adjacent to each of the main surface, the first side surface, and the second side surface;
a coil disposed inside the element body and including a coil axis perpendicular to the main surface; and
an external electrode disposed on the main surface, the first side surface, the second side surface, and the third side surface,
wherein the element body includes:
a first element body region located between the first side surface and the coil in the direction; and
a second element body region located between the second side surface and the coil in the direction,
wherein the first element body region has a resistivity higher than a resistivity of the second element body region, and
wherein the first element body region is shorter than the second element body region in the direction.
